(19) United States
(12) Patent Application Publication
(10) Pub. No.: US 2016/0109360 A1
(43) Pub. Date: Apr. 21, 2016

(54) INSPECTION APPARATUS, INSPECTION METHOD, AND STORAGE MEDIUM

(71) Applicant: CANON KABUSHIKI KAISHA, Tokyo (JP)

(72) Inventor: Takayuki Koizumi, Yokohama-shi (JP)

(21) Appl. No.: 14/880,603

(22) Filed: Oct. 12, 2015

(30) Foreign Application Priority Data
Oct. 15, 2014 (JP) 2014-211198
Aug. 28, 2015 (JP) 2015-169238

(51) Int. Cl. G01N 21/35; G01N 21/55; G01N 21/59

(52) U.S. Cl. CPC G01N 21/35; G01N 21/59; G01N 21/55

(57) ABSTRACT

An inspection apparatus to inspect a plurality of inspection objects includes first and second measuring units, a determining portion, and a separating unit. The first measuring unit measures terahertz waves transmitted through, or reflected by, the plurality of respective inspection objects. The determining portion determines whether a predetermined condition is satisfied by using a measurement result of the first measuring unit. The separating unit separates the plurality of inspection objects into an inspection object that satisfies the predetermined condition and an inspection object that does not satisfy the predetermined condition based on a determination result of the determining portion. The second measuring unit measures a time waveform of a terahertz-wave pulse transmitted through an inspection object that does not satisfy the predetermined condition separated by the separating unit or a terahertz-wave pulse reflected by the inspection object that does not satisfy the predetermined condition separated by the separating unit.

### BACKGROUND OF THE INVENTION

1. Field of the Invention

The present invention relates to an inspection apparatus and an inspection method using a terahertz wave, and a storage medium.

2. Description of the Related Art

In recent years, there has been developed a nondestructive sensing technology using electromagnetic waves containing components in a frequency band from 30 GHz to 30 THz or from a millimeter-wave band to a terahertz-wave band (hereinafter, merely referred to as “terahertz wave”). Application of the sensing technology using this terahertz wave has been considered as an inspection unit or method that executes nondestructive quality check in a manufacturing process. That is, application to inspections for a foreign substance in a particulate material, the mixing ratio or mixing properties of a mixed particulate material, chipping of a solid, such as a tablet or a plate, due to tableting, melting, etc., and the density of the solid.

U.S. Pat. No. 7,907,024 (Patent Document 1) discloses an inspection apparatus using a plurality of resonant tunneling diodes having different oscillation frequencies as terahertz-wave oscillators. To be specific, by using the plurality of terahertz-wave oscillators, an inspection object is irradiated with terahertz waves with a plurality of different frequencies, and the terahertz waves transmitted through the inspection object or reflected by the inspection object are detected. The inspection apparatus in Patent Document 1 inspects whether or not a certain substance is included in the inspection object. The inspection apparatus stores a pattern of an absorption spectrum, such as the characteristic peak position of the absorption spectrum of a substance desired to be detected with a single frequency or a plurality of frequencies. Then, the stored pattern of the absorption spectrum is compared with the detection result obtained by detecting the terahertz wave, and the presence of the substance is inspected.

Also, U.S. Pat. No. 5,710,430 (Patent Document 2) discloses a terahertz time-domain spectroscopy (THz-TDS) apparatus that acquires a time waveform of a pulse wave of a terahertz wave transmitted through an inspection object by using the THz-TDS method. In Patent Document 2, information such as optical characteristics etc. of the inspection object is acquired by analyzing a spectrum obtained by executing Fourier transform on the acquired time waveform. Then, the acquired information of the inspection object is compared with previously acquired information which is a database on a substance basis for a plurality of substances, and the information of the inspection object is identified every measurement point. By moving the measurement point on the inspection object by moving the inspection object, an image of the inspection object based on the optical characteristics etc. can be obtained.

Like Patent Document 1, the inspection apparatus using the terahertz-wave oscillator using a semiconductor element such as a Schottky barrier diode has a small apparatus size and a short measurement time. Hence, the inspection apparatus is suitable for 100-percent inspection in a production line (hereinafter, referred to as in line). However, the information that can be acquired is typically the intensity of terahertz wave transmitted through or reflected by an inspection object. Also, the optical characteristics are limited to the reflectivity, transmissivity, etc. with an oscillation frequency. Therefore, the presence of defectiveness or the presence of abnormality of an inspection object can be determined; however, the information to be obtained of the inspection object may be occasionally less than that of the THz-TDS apparatus.

In contrast, for example, information of an inspection object is desired to be acquired by executing a sampling inspection for the purpose of specifying the factor of defectiveness outside the production line (hereinafter, referred to as out line), a THz-TDS apparatus like Patent Document 2 can be used. That is, the thickness and inner structure of the inspection object, and physical quantities, such as a complex refractive index and a complex dielectric constant, can be acquired from a time waveform, an amplitude spectrum, a phase spectrum, etc., to be acquired. However, the size of apparatus is larger and the measurement time is longer than those of the inspection apparatus using the semiconductor device.

### SUMMARY OF THE INVENTION

According to an aspect of the present invention, an inspection apparatus configured to inspect a plurality of inspection objects includes a first measuring unit configured to measure terahertz waves transmitted through the plurality of respective inspection objects or reflected by the plurality of respective inspection objects, a determining portion configured to determine whether a predetermined condition is satisfied by using a measurement result of the first measuring unit, a separating unit configured to separate the plurality of inspection objects into an inspection object that satisfies the predetermined condition and an inspection object that does not satisfy the predetermined condition based on a determination result of the determining portion, and a second measuring unit configured to measure a time waveform of a terahertz-wave pulse transmitted through an inspection object that does not satisfy the predetermined condition separated by the separating unit or a terahertz-wave pulse reflected by the inspection object that does not satisfy the predetermined condition separated by the separating unit.

Further aspects of the present invention will become apparent from the following description of exemplary embodiments with reference to the attached drawings.

### BRIEF DESCRIPTION OF THE DRAWINGS

FIG. 1A is a side view explaining a configuration of an inspection apparatus according to a first embodiment.

FIG. 1B is a top view explaining the configuration of the inspection apparatus according to the first embodiment.

FIG. 2 is a flowchart explaining an example of an inspection method according to the first embodiment.

FIG. 3A is a side view explaining a configuration of an inspection apparatus according to a second embodiment.

FIG. 3B is a top view explaining the configuration of the inspection apparatus according to the second embodiment.

FIG. 4 is a flowchart explaining an example of an inspection method according to the second embodiment.

FIG. 5 is a schematic view explaining an example of a configuration of a first measuring unit of an inspection apparatus according to a third embodiment.

FIG. 6 is a schematic view explaining an example of a configuration of a first measuring unit of an inspection apparatus according to a fourth embodiment.

### DESCRIPTION OF THE EMBODIMENTS

The present invention is made to address the above-described problems in an inspection apparatus using a terahertz wave. The present invention provides an inspection apparatus that can determine whether or not an inspection object satisfies a condition in line and can acquire information of the inspection object that does not satisfy the condition. Hereinafter, embodiments of the present invention are described.

### First Embodiment

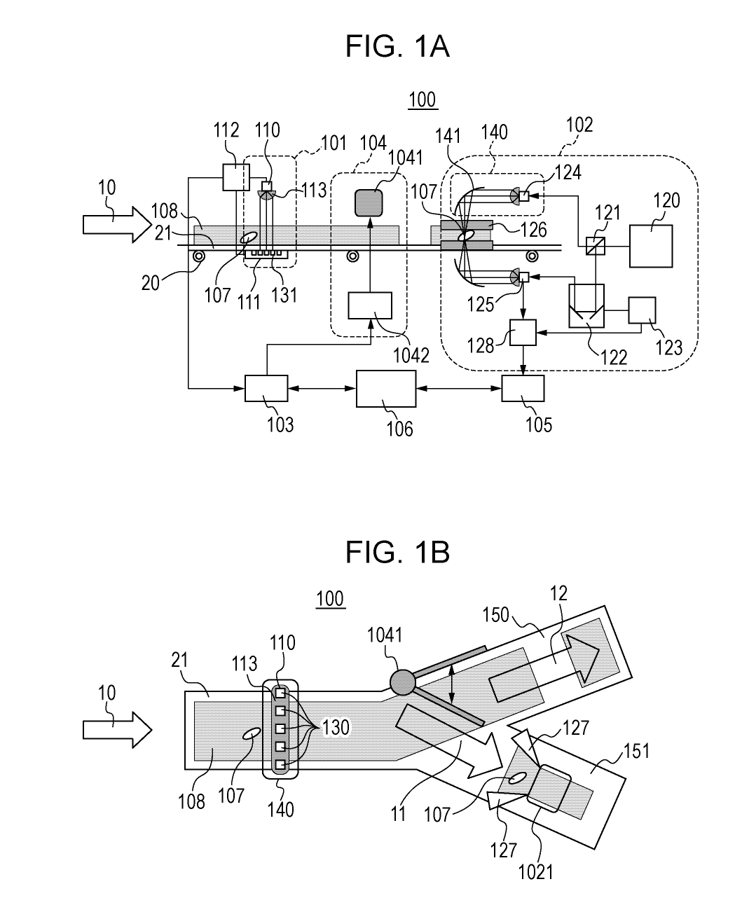

An inspection apparatus 100 (hereinafter, referred to as “apparatus 100”) according to a first embodiment is described. First, a configuration of the apparatus 100 is described, and then an inspection method is described. FIG. 1A is a side view explaining the configuration of the apparatus 100, and FIG. 1B is a top view explaining the configuration of the apparatus 100. In this embodiment, it is determined whether an inspection object 108 arranged on a conveying unit 21 satisfies a predetermined condition or not by using a terahertz wave, and information of the inspection object 108 determined as not satisfying the condition is acquired.

The conveying unit 21 moves the particulate material 108 arranged on the conveying unit 21 in a conveying direction 10. To be specific, the conveying unit 21 is a belt conveyor etc. that moves by a position changing portion 20 such as a wheel.

The information of the inspection object 108 is used for rechecking whether the condition is satisfied or not or for specifying the factor that does not satisfy the condition. The apparatus 100 can execute an inspection for a tablet, a plastic member, a toner, a nanocomposite material, etc., as the inspection object 108. In this embodiment, a particulate material is used as the inspection object 108.

In this embodiment, it is assumed that the particulate material 108 satisfies a predetermined condition if the particulate material 108 is a good product without a possibility of being a defective product, and the particulate material 108 does not satisfy the predetermined condition if the particulate material 108 is a product with a possibility of being a defective product. The factors that cause the particulate material 108 to become a defective product are, for example, mixing of a foreign substance, chipping of a solid, a deviation in mixing ratio of raw materials of an inspection object, insufficiency in mixing properties of raw materials, and so force. In the description of this embodiment, for example, a case in which the particulate material 108 includes a foreign substance 107 is expected.

The apparatus 100 includes a first measuring unit 101 and a second measuring unit 102. Also, the apparatus 100 includes a determining portion 103, a separating unit 104, an information acquiring portion 105 (hereinafter, referred to as “acquiring portion 105”), a memory portion 106, and a first controller 112. A measurement time of the first measuring unit 101 is shorter than a measurement time of the second measuring unit 102. A frequency range of the terahertz waves used by the first measuring unit 101 is narrower than a frequency range of the terahertz-wave pulses used by the second measuring unit 102.

The first measuring unit 101 is a unit configured to execute measurement for determining whether the particulate material 108 satisfies a predetermined condition or not by using a terahertz wave. The first measuring unit 101 measures a terahertz wave transmitted through the particulate material 108. The first measuring unit 101 includes a terahertz-wave generating portion 110 (hereinafter, referred to as “generating portion 110”), a lens 113 that shapes the generated terahertz wave, and a terahertz-wave detecting portion 111 (hereinafter, referred to as “detecting portion 111”).

The generating portion 110 is a portion configured to generate a terahertz wave. The generating portion 110 has a plurality of terahertz-wave generating elements 130 (hereinafter, referred to as “generating elements 130”) arranged in a linear form for executing 100-percent inspection of the particulate material 108 in line. Terahertz waves generated by the plurality of generating elements 130 are shaped into parallel light in a linear form by the lens 113 like, for example, a cylindrical lens, and the parallel light is emitted on the particulate material 108. The plurality of generating elements 130 generate terahertz waves with the same frequency. Also, to increase resolution, the light may be collected so that the light is focused in the particulate material 108.

It is desirable that the generating element 130 is small, operates at high speed, and can generate a terahertz wave with high intensity. To be specific, a resonant tunneling diode or the like may be used. Alternatively, the generating portion 110 is not limited thereto, and may use a terahertz-wave generating element that uses a laser light from a small semiconductor laser for exiting light, and uses generation of a terahertz wave with a difference frequency or a sum frequency in a nonlinear optical crystal, such as LiNbO₃. In this case, a system of using electro-optic Cherenkov radiation may be used. The generating portion 110 is not limited to the above-described configuration, and may employ a configuration that irradiates the particulate material 108 with a terahertz wave generated by a single generating element 130 and shaped as linear light beams by using a plurality of lenses 113.

The detecting portion 111 detects a terahertz wave. The detecting portion 111 has a plurality of terahertz-wave detecting elements 131 (hereinafter, referred to as “detecting element 131”) integrated in an array form. To be specific, in the detecting portion 111, the plurality of detecting elements 131 are arranged with regularity in a planar form. It is desirable that the detecting portion 111 is small and operates at high speed, and can detect a terahertz wave with high sensitivity, for executing 100-percent inspection of the particulate material 108 in line. Hence, for example, the detecting element 131 may be a Schottky barrier diode, a semiconductor diode with a low forward voltage drop and a very fast switching action. Also, if the measurement speed does not have to be high, a thermal detector such as a microbolometer, FET (field-effect transistor), or HEMT (high-electron-mobility transistor) may be used.

To efficiently detect the terahertz wave generated from the generating portion 110, a region where the detecting portion 111 can detect the terahertz wave (detection region) 140 is desirably larger than the irradiation region on the particulate material 108 with the terahertz wave. If a Schottky barrier diode is used as the detecting element 131, the detecting element 131 measures an electric signal proportional to the electric-field amplitude of the terahertz wave, and the intensity of the terahertz wave is detected as the detection result.

Hereinafter, the generating element 130 is described as a resonant tunneling diode, and the detecting element 131 is described as a Schottky barrier diode. A terahertz wave generated from the resonant tunneling diode serving as the generating element 130 is typically a continuous wave with a narrow frequency band. Hence, it is desirable to select and combine a Schottky barrier diode serving as the detecting element 131 with the highest sensitivity in the frequency domain of the terahertz wave generated by the generating element 130. Also, the respective generating elements 130 are desirably adjusted or controlled so that generation efficiency has no variation to correctly determine the presence of a possibility being a defective product of the particulate material 108. Similarly, the respective detecting elements 131 are desirably adjusted or controlled so that detection efficiency has no variation.

The first controller 112 controls driving of the generating portion 110, and adjusts a voltage to be applied to the generating portion 110 and the detecting portion 111. Also, the first controller 112 reads the detection result detected by each of the plurality of detecting elements 131 as a signal, and acquires an intensity distribution of the terahertz wave transmitted through the particulate material 108, the intensity distribution being associated with positional information of the detecting elements 131. Accordingly, a temporally continuous intensity distribution can be obtained for the particulate material 108 passing through the detection region 140. The acquired intensity distribution is transferred to the determining portion 103.

In this embodiment is the configuration that detects the terahertz wave transmitted through the particulate material 108 is provided. In this case, it is desirable that the conveying unit 21 uses resin or the like that transmits the terahertz wave well as a material, and has a surface shape being flat by a certain degree to prevent scattering of the terahertz wave. Also, an antireflection film (not shown) may be arranged on a surface of the conveying unit 21 on which the particulate material 108 is arranged so that the antireflection film hardly reflects the terahertz wave.

Alternatively, a configuration that detects the terahertz wave reflected by the particulate material 108 may be employed. In this case, the terahertz wave is incident at an incidence angle on the particulate material 108. Also, the generating portion 110 and the detecting portion 111 (not shown) are arranged to efficiently detect the terahertz wave reflected by the particulate material 108. In this case, it is desirable that a metal thin film or the like that reflects the terahertz wave well is arranged on the surface of the conveying unit 21 on which the particulate material 108 is arranged. Alternatively, the conveying unit 21 may be configured by using a material that reflects the terahertz wave well. The intensity distribution of the terahertz wave transmitted through the particulate material 108 is information that reflects the transmissivity of the particulate material 108. The intensity distribution of the terahertz wave reflected by the particulate material 108 is information that reflects the reflectivity of the particulate material 108.

The determining portion 103 determines whether the measurement result of the first measuring unit 101 satisfies a predetermined condition or not. In this case, it is determined whether or not each of the plurality of particulate materials 108 has a possibility of being a defective product by using the measurement result of the first measuring unit 101 and a reference value. To be specific, the intensity of the terahertz wave as the measurement result of the first measuring unit 101, or the transmissivity or reflectivity that can be acquired from the intensity is compared with a reference value stored in the memory portion 106, and the presence of a possibility of being a defective product is determined based on the comparison result. In this embodiment, the determining portion 103 compares the intensity of the terahertz wave detected by each of the detecting elements 131 transferred from the first controller 112, with the reference value of the intensity set for each detecting element 131. If the acquired intensity is within a range of the reference value, the determining portion 103 determines that the inspection object 108 has no possibility of being a defective product. If the acquired intensity is not within the range of the reference value, the determining portion 103 determines that the inspection object 108 has a possibility of being a defective product, that is, the inspection object 108 is an inspection object that does not satisfy the predetermined condition.

The reference value is a standard intensity distribution in a state without the foreign substance 107, that is, in a good product, and is stored in the memory portion 106. To avoid an erroneous operation that incorrectly determines the inspection object 108 with no possibility of being a defective product as the inspection object 108 with a possibility of being a defective product, it is desirable to set the reference value to have a certain width. For example, a time average value of the intensity distribution acquired by measuring the particulate material 108 of a good product without the foreign substance 107 for a certain time by using the first measuring unit 101 is set at the center value of the reference values. When the variation of the intensity distribution is expressed by a standard deviation σ, for example, if an error of about 1% is permitted, a width of about ±3σ from the center value may be set. Of course, the width of the reference value may be other values, and the width is desirably set in accordance with each inspection object.

The intensity distribution acquired by using the detection result of the detecting portion 111 acquired when a portion of the particulate material 108 including the foreign substance 107 passes through the detection region 140 has generated therein scattering, absorption, refraction, reflection, transmission, etc., of the terahertz wave due to the foreign substance 107. Owing to this, the intensity distribution of the terahertz wave of the portion with the foreign substance 107 is modulated as compared with the intensity distribution of other portion without the foreign substance 107. Hence, if the first measuring unit 101 determines whether or not the intensity distribution is within the range of the reference value, the presence of a possibility of being a defective product can be inspected. If the intensity distribution is outside the range of the reference value, the determining portion 103 gives a second controller 1042 of the separating unit 104 a command of separating the particulate materials 108 around the foreign substance 107. The above-described configuration is for inspecting whether the inspection object 108 satisfies the predetermined condition or not from the measurement result of the first measuring unit 101.

The separating unit 104 separates particulate materials 108 to a particulate material 108 that has no possibility of being a defective product or that satisfies the predetermined condition, and a particulate material 108 that has a possibility of being a defective product or that does not satisfy the predetermined condition, based on the determination result of the determining portion 103. In this case, the separating unit 104 separates the particulate materials 108 into the particulate material 108 being a good product without the foreign substance 107, and the particulate material 108 being a defective product including the foreign substance 107. The particulate material 108 of a good product is sent to a second conveying unit 150 by the separating unit 104, and is conveyed in a conveying direction 12. The particulate material 108 with a possibility of being a defective product is sent to a third conveying unit 151 by the separating unit 104, and is conveyed in a conveying direction 12. The separating unit 104 includes a separator 1041 that executes separation and the second controller 1042 that controls the separator 1041, for reliably separating the particulate material 108 including the foreign substance 107 in a conveying direction 11.

The second controller 1042 calculates the time after reception of a signal indicative of that the particulate material 108 with a possibility of including the foreign substance 107 is detected from the determining portion 103 until the particulate material 108 with a possibility of including the foreign substance 107 reaches the separator 1041. The time required until the particulate material 108 with a possibility of including the foreign substance 107 reaches the separator 1041 can be calculated by using a previously set conveying speed of the conveying unit 21 and the distance from the detection region 140 to the separator 1041. Also, the second controller 1042 calculates the length of time the separator 1041 separates the particulate material 108 to the third conveying unit 151 based on the area of the detection region 140 and the conveying speed of the conveying unit 21. Accordingly, the second controller 1042 has a role of acquiring the time point at which the separator 1041 sends the particulate material 108 to the third conveying unit 151 and the length of sorting time, and operating the separator 1041 based on the time point and the separating time. These values do not have to be obtained by calculation every time, and previously acquired numerical values may be used.

As shown in FIG. 1B, the separator 1041 is a gate that changes the conveying direction of the particulate material 108. Other than changing the conveying direction of the particulate material 108 by opening and closing the gate, for example, the separator 1041 may push out only a portion of the particulate material 108 that is determined as not satisfying the predetermined condition, and may arrange the portion at the third conveying unit 151. Alternatively, the conveying direction of only a region of the conveying unit 21 where the particulate material 108 including the foreign substance 107 is present may be changed to the conveying direction 11, and the configuration may separate the inspection object 108 depending on the presence of defectiveness. Also, the separator 1041 is not limited to a single separator, and a plurality of the separators 1041 may be arranged in parallel along the conveying direction 11.

The particulate material 108 determined as having a possibility of being a defective product by the determining portion 103 is separated by the separating unit 104, and then is guided to the second measuring unit 102 by the third conveying unit 151. The particulate material 108 including the foreign substance 107 separated in the conveying direction 11 is pushed out while being adjusted to be arranged within a measurement region 1021 by a checker 127. With this form, the time waveform of the terahertz wave of the particulate material 108 pushed out by the checker 127 is successively measured in the measurement region 1021.

Also, if the position of the foreign substance 107 is not changed in the particulate material 108 or if the foreign substance 107 is large, measurement may be executed without using the checker 127. In this case, line scanning may be executed by scanning with the terahertz wave in a direction orthogonal to the conveying direction 11 when the particulate material 108 passes through the measurement region 1021. Accordingly, an image formed by two-dimensionally scanning the particulate material 108 can be obtained.

The second measuring unit 102 includes a light source 120, a beam splitter 121, a pulse-wave irradiating portion 140 (hereinafter, referred to as “irradiating portion 140”), a pulse-wave detecting portion 125 (hereinafter, referred to as “detecting portion 125”), an adjusting portion 122, a third controller 123, a waveform acquiring portion 128, and a measurement window 126. While the particulate material 108 and the foreign substance 107 are sandwiched by the measurement window 126 in the second measuring unit 102, the particulate material 108 is desirably irradiated with the terahertz wave through the window 126. With this configuration, the particulate material 108 is flattened and hence irregular reflection or scattering of the terahertz wave at the surface of the particulate material 108 can be prevented from occurring. The material of the measurement window 126 may be a material with high transmissivity with respect to the terahertz wave. For example, a crystal cut at a Z-surface; or synthetic quartz, sapphire, diamond, high-resistant silicon, or a resin material may be used.

The light source 120 is a portion that outputs an ultrashort pulse laser light. The ultrashort pulse laser light output from the light source 120 is a femto-second laser light. It is assumed that the “ultrashort pulse laser light” in this specification is pulse light having a pulse width of several hundreds of femto-seconds or smaller. In particular, an ultrashort pulse laser light having a pulse width in a range from 1 fs to 100 fs is called femto-second laser light.

The irradiating portion 140 is a portion that irradiates the inspection object 108 with a terahertz-wave pulse. The irradiating portion 140 includes a pulse generating portion 124 (hereinafter, referred to as “generating portion 124”) that generates a terahertz-wave pulse, and an optical system 141 that guides the terahertz-wave pulse generated at the generating portion 124 to the inspection object. Hereinafter, the terahertz-wave pulse is called “pulse wave.” The ultrashort pulse laser light emitted from the light source 120 is divided into two by the beam splitter 121. If one of the divided laser light is emitted on the generating portion 124, a pulse wave is generated.

A method of generating a pulse wave at the generating portion 124 may be, for example, a method of using instantaneous carrying current and a method of using inter-band transition. The method of using instantaneous carrying current may be, for example, a technique of generating a pulse wave by irradiating a semiconductor, an organic crystal, or a nonlinear optical crystal with a laser light. Also, a technique of applying an electric field to a photoconductive element in which an antenna pattern is formed with a metal electrode on a semiconductor thin film, and irradiating the applied portion with a laser light may be applied. The technique of using inter-band transition may be, for example, a technique of using a semiconductor quantum well structure.

Regarding the pulse wave generated at the generating portion 124, the beam shape of the terahertz wave is shaped through the optical system 141 including a hemispherical lens and a parabolic-surface mirror, and the shaped pulse wave is emitted on the particulate material 108 including the foreign substance 107. At this time, the pulse wave is desirably emitted through the measurement window 126. Also, to increase the resolution, the beam of the pulse wave may be focused at the particulate material 108. The optical system 141 that shapes the pulse wave and guides the pulse wave to the particulate material 108 may be configured by properly combining, for example, a hemispherical lens, a hyper-hemispherical lens, a parabolic-surface mirror, and a flat-surface mirror.

The pulse wave emitted on the particulate material 108 through the measurement window 126 is transmitted through the particulate material 108 including the foreign substance 107, and is detected by the detecting portion 125. The detection method of the detecting portion 125 may be, for example, a technique of detecting current in accordance with the amplitude of the pulse wave by using a photoconductive element, or a technique of detecting an electric field by using an electro-optic effect with use of an orthogonal polarizer and an electro-optic crystal. Also, a technique of detecting a magnetic field by using an orthogonal polarizer and a magneto-optic crystal may be applied. When the pulse wave incident on the detecting portion 125 is focused at the detecting portion 125, the intensity per unit area can be increased, and the detection sensitivity can be increased. In this embodiment, the pulse wave transmitted through the particulate material 108 is detected by the detecting portion 125; however, the pulse wave reflected by the particulate material 108 may be detected.

The adjusting portion 122 adjusts the time point at which the pulse wave is detected by the detecting portion 125. The adjusting portion 122 of this embodiment changes relative optical path lengths of the ultrashort pulse laser light input to the detecting portion 125 and the ultrashort pulse laser light input to the generating portion 124. A method of adjusting the optical path length may be a method of physically changing the optical path length by using a folding optical system and a movable portion. Also, for example, a method of changing the optical path length by changing the refractive index or the like in a propagation path may be applied. The third controller 123 controls operations of respective configurations of the second measuring unit 102 including the adjusting portion 122.

In this embodiment, the optical path length of the ultrashort pulse laser light from the light source 120 to the detecting portion 125 is adjusted by using a retardation stage including a folding optical system and a movable portion as the adjusting portion 122. The adjusting portion 122 is provided between the light source 120 and the detecting portion 125, and the optical path length of the ultrashort pulse laser light that propagates between the light source 120 and the detecting portion 125 is adjusted. However, without limiting to this method, a retardation stage serving as the adjusting portion 122 may be provided in the path of the ultrashort pulse laser light to be input to the generating portion 124, and hence the optical path length of the ultrashort pulse laser light to be input to the generating portion 124 may be changed.

In general, the time required for measuring the time waveform of the pulse wave is longer than the time required for measuring the intensity distribution of the terahertz wave by the first measuring unit 101. Hence, the speed at which the particulate material 108 is conveyed in the conveying direction 11 is desirably lower than the speed at which the particulate material 108 is conveyed in the conveying directions 10 and 12. Alternatively, if the particulate material 108 is arranged in the measurement region 1021, the conveying unit 150 may temporarily stop the conveyance.

The waveform acquiring portion 128 acquires the time waveform of the pulse wave by using the detection result of the detecting portion 125. To be specific, the waveform acquiring portion 128 acquires the time waveform from the adjusting amount of the optical path length by the adjusting portion 122 and the output (the detection result) of the detecting portion 125.

As described above, the second measuring unit 102 acquires the time waveform of the pulse wave transmitted through the particulate material 108 including the foreign substance 107 pushed out to the measurement region 1021. The acquired time waveform is sent to the information acquiring portion 105 together with the positional information of the particulate material 108 on the conveying unit 151.

The information acquiring portion 105 acquires information of the particulate material 108 including the foreign substance 107 from the time waveform acquired by the second measuring unit 102. In this case, the information of the particulate material 108 includes a three-dimensional shape of the foreign substance 107, information of a structure such as an inner boundary surface of the foreign substance 107 or the particulate material 108, and optical characteristics of the particulate material 108. To be specific, the optical characteristics include a reflectivity spectrum, a transmissivity spectrum, a refractive index spectrum, a dielectric constant spectrum, a complex reflectivity spectrum, a complex refractive index spectrum, a complex dielectric constant spectrum, a complex electrical conductivity spectrum, etc., in the terahertz wave region. Also, values of the above-described various spectra with a certain frequency may be included.

The information acquiring portion 105 compares the obtained optical-characteristic spectrum (measurement spectrum) with a reference spectrum. If the measurement spectrum and the reference spectrum do not satisfy the matching condition, the factor of abnormality to be a defective product is specified. A method of specifying the factor of abnormality is executing matching between a plurality of spectra acquired by measurement for the inspection object 108 not being a good product obtained from the database stored in the memory portion 106 and the measurement spectrum. That is, it is checked wither or not a spectrum that satisfies the matching condition with the measurement spectrum is present in the data base. If the spectrum that satisfies the matching condition with the measurement spectrum is not present in the data base, the measurement spectrum is stored in the database for expansion of the database. Also, an indication of recommending determination of the factor of abnormality by executing analysis with other analyzer (not shown) is displayed on a display (not shown). The display may employ a display in a system that executes manufacturing management, an in-line display, or lighting of Patlite (registered trademark).

In this embodiment, the memory portion 106 stores the reference value used by the determining portion 103 and the information including the reference spectrum used for re-determination of whether or not the particulate material is a defective product or not and the plurality of spectra used for specifying the factor of abnormality used by the information acquiring portion 105. The memory portion 106 is not limited to this form, and the determining portion 103 and the information acquiring portion 105 may include respective memory portions. Also, the memory portion 106 is a storage medium storing a program that causes the inspection apparatus 100 to execute respective steps of an inspection method (described later). Each of the first controller 112, the second controller 1042, and the third controller 123 is specifically a computer including a central processing unit (CPU), a memory, a storage device, etc., and is connected to the inspection apparatus 100. The first controller 112, the second controller 1042, and the third controller 123 may be a single computer or may use a plurality of computers. Also, part of the function of each of the first controller 112, the second controller 1042, and the third controller 123 may be substituted by hardware such as a logic circuit, or may be configured of dedicated hardware such as a board computer or an application specific integrated circuit (ASIC).

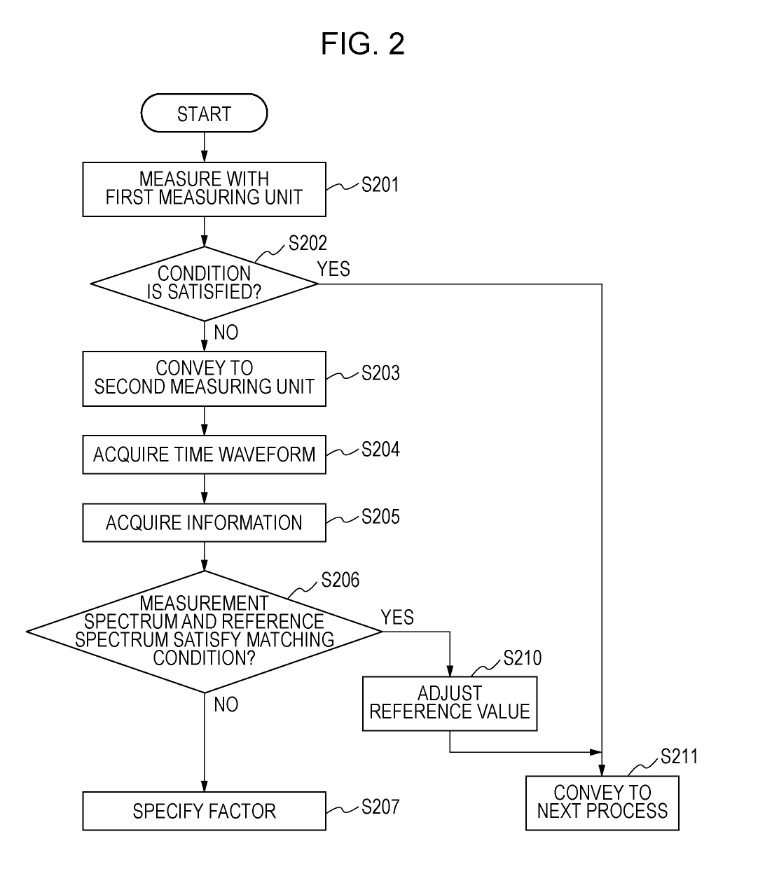

An inspection method of the inspection object 108 by using the apparatus 100 is described. FIG. 2 is a flowchart explaining an example of the inspection method by the apparatus 100. To be specific, the method is an inspection flow of determining whether or not the predetermined condition is satisfied, acquiring the information of the inspection object, and specifying the factor of defectiveness, by using the apparatus 100.

First, in step S201, in the first measuring unit 101, the generating portion 110 irradiates a particulate material 108 with a terahertz wave through the lens 113, and the detecting portion 111 detects the terahertz wave transmitted through the particulate material 108. The detection result of the detecting portion 111 is transferred to the determining portion 103, and the determining portion 103 acquires the intensity distribution of the terahertz wave (S201).

Then, the determining portion 103 compares the acquired intensity distribution with a reference value referenced from the memory portion 106, and determines whether or not the predetermined condition is satisfied (S202). In this case, the intensity of the terahertz wave detected by each detecting element 131 is compared with a reference value previously acquired for each detecting element 131. As the result of comparison, if the intensity is within the range of the reference value for all the detecting elements 131, the determining portion 130 determines that the particulate material 108 is a good product, that is, satisfies the predetermined condition. The conveying unit 21 conveys the particulate material 108 in the conveying direction 12 to send the particulate material 108 to the next process (S211).

In contrast, as the result of comparison, if the intensity is outside the range of the reference value, the determining portion 103 determines that the particulate material 108 has a possibility of being a defective product, and the process goes to step S203. In step S203, the separating unit 104 separates a particulate material 108 that does not satisfy the predetermined condition from among particulate materials 108, and conveys the separated particulate material 108 in the conveying direction 11. Then, the second measuring unit 102 measures the time waveform of the terahertz wave transmitted through the particulate material 108 sent in the conveying direction 11 (S204). At this time, the size of the particulate material 108 is adjusted as required. Then, the information acquiring portion 105 acquires information of the particulate material 108 by using the time waveform acquired by the time-waveform acquiring portion 128 of the second measuring unit 102 (S205). A certain optical-characteristic spectrum included in the information of the particulate material 108 acquired in step S205 is considered as a measurement spectrum, and the measurement spectrum is compared with a reference spectrum (S206).

As the result of comparison in step S206, if the measurement spectrum and the reference spectrum satisfy the matching condition, the determining portion 103 adjusts the reference value of the intensity distribution in response to an instruction from the information acquiring portion 105. To be specific, the determining portion 103 takes a measure of, for example, expanding the width of the reference value reflecting the transmissivity or reflectivity. Also, if the measurement spectrum and the reference spectrum satisfy the matching condition, the information acquiring portion 105 determines the particulate material 108 as being a good product, and sends the inspected particulate material 108 to the conveying unit 151 to convey the particulate material 108 to the next process similarly to the good product (S210). If the measurement spectrum and the reference spectrum do not satisfy the matching condition, a database of defective products stored in the memory portion 106 is further referenced, matching is executed with respect to a spectrum of a defective product, and the factor of defectiveness is specified (S207). If the database does not include the spectrum that satisfies the matching condition with the measurement spectrum and the factor of defectiveness is not specified, the measurement spectrum may be stored in the memory portion 106, so that the database may be further expanded.

With this embodiment, it is determined whether or not the inspection object satisfies the predetermined condition in line, and the information of the inspection object that does not satisfy the predetermined condition can be obtained. Since it can be rechecked whether the predetermined condition is satisfied or not by using the information of the inspection object acquired by the information acquiring portion, the accuracy of the inspection can be increased. Also, the processing for specifying the factor of abnormality can be executed by using the information of the inspection object acquired by the information acquiring portion. If a new factor not included in the database stored in the memory portion 106 is present, the spectrum of a defective product generated by the new factor is added to the database, and hence the accuracy of the inspection can be increased. Further, for example, if the factor of abnormality acquired from the information of the inspection object is fed back to the manufacturing process and the condition in the manufacturing process is changed, this may contribute to restriction of generation of a defective product.

### Second Embodiment

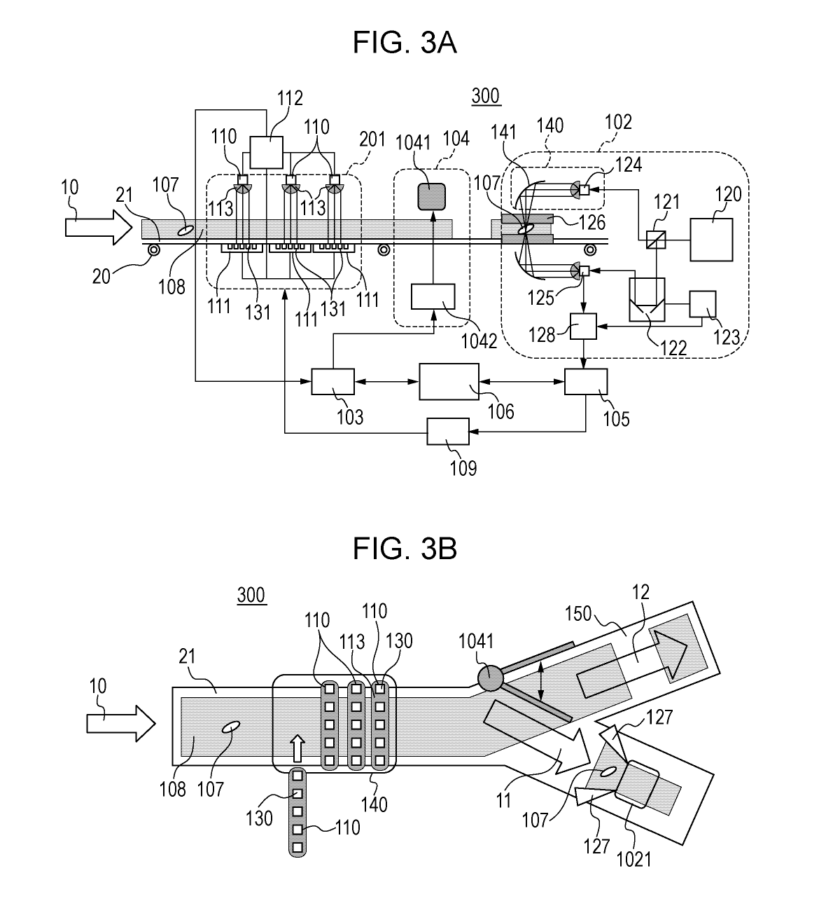

An inspection apparatus 300 (hereinafter, referred to as “apparatus 300”) according to a second embodiment is described. The description for a portion common to that in the above description is omitted, and a portion not being common is described with reference to FIGS. 3A and 3B. First, a configuration of the apparatus 300 is described. FIG. 3A is a side view explaining the configuration of the apparatus 300, and FIG. 3B is a top view explaining the configuration of the apparatus 300. A particulate material 108 serving as an inspection object is conveyed by the conveying unit 21 such as a wheel in the conveying direction 10 with time.

The apparatus 100 in the first embodiment includes the single first measuring unit 101. In contrast, the apparatus 300 includes a third measuring unit 201. The third measuring unit 201 includes a plurality of the first measuring units 101. The plurality of first measuring units 101 are arranged side by side along the conveying direction 10. The configuration of each first measuring unit 101 is similar to that of the first embodiment. Also, the apparatus 300 includes a fourth controller (frequency controller) 109.

The fourth controller 109 gives the third measuring unit 201 a command of newly adding the first measuring unit 101 to the apparatus 300, and gives the first controller 112 a command of changing the oscillation frequency of the terahertz wave generated by the generating portion 110 of the first measuring unit 101 and the frequency that can be detected by the detecting portion 111 with high sensitivity as required.

As described above, the factor of abnormality is not limited to that the foreign substance 107 is mixed in the particulate material 108. The factor may be the mixing ratio or mixing properties of a mixed particulate material, chipping of a solid, such as a tablet or a plate, due to tableting, melting, etc. There are many other factors of abnormality, and the presence of abnormality may not be occasionally determined merely by irradiation with a terahertz wave with a single frequency.

For example, if a mixture in which a plurality of different raw materials are mixed is used as the particulate material 108, if a deviation in mixing ratio of the raw materials is the factor of abnormality, the presence of abnormality can be determined by using characteristic absorption spectra in frequency domains of terahertz waves of the respective raw materials. To be specific, the frequency of the terahertz wave that is generated by the generating portion 110 of each of the plurality of first measuring units 101 and the frequency of the terahertz wave that can be detected by the corresponding detecting portion 111 with high sensitivity are adjusted to the peak position of the absorption spectrum of each of the raw materials of the particulate material 108. If the detection results of the respective detecting portions 111 are used, it can be determined whether the mixing ratio has abnormality or not.

Also, in the case in which the mixture in which the plurality of different raw materials is mixed is used as the particulate material 108, if the mixing properties of the raw materials are bad, the raw materials may not be uniformly dispersed, specific raw materials may be physically coupled, or other component (a foreign substance) other than the raw materials may be mixed. In this case, the frequency of the terahertz wave from the generating portion 110 may be adjusted in accordance with for example, the frequency at the peak of the absorption spectrum obtained as the result of vibration generated when the raw materials are physically coupled, or the frequency at the peak of the absorption spectrum of the component other than the raw materials. Also, the frequency of the terahertz wave that can be detected by the detecting portion 111 with high sensitivity may be adjusted in accordance with the frequency of the terahertz wave from the generating portion 110.

A defective product due to the factor of, for example, chipping of a solid has a spatial resolution that is determined in accordance with the wavelength of the terahertz wave generated by the generating portion 110. Therefore, to find out abnormality due to small chipping by an inspection, it is required to increase the oscillation frequency to increase the spatial resolution. With the above description, it is effective to include the plurality of first measuring units 101 so that measurement using terahertz waves with a plurality of different frequencies can be executed for the purpose of determining abnormality due to various factors.

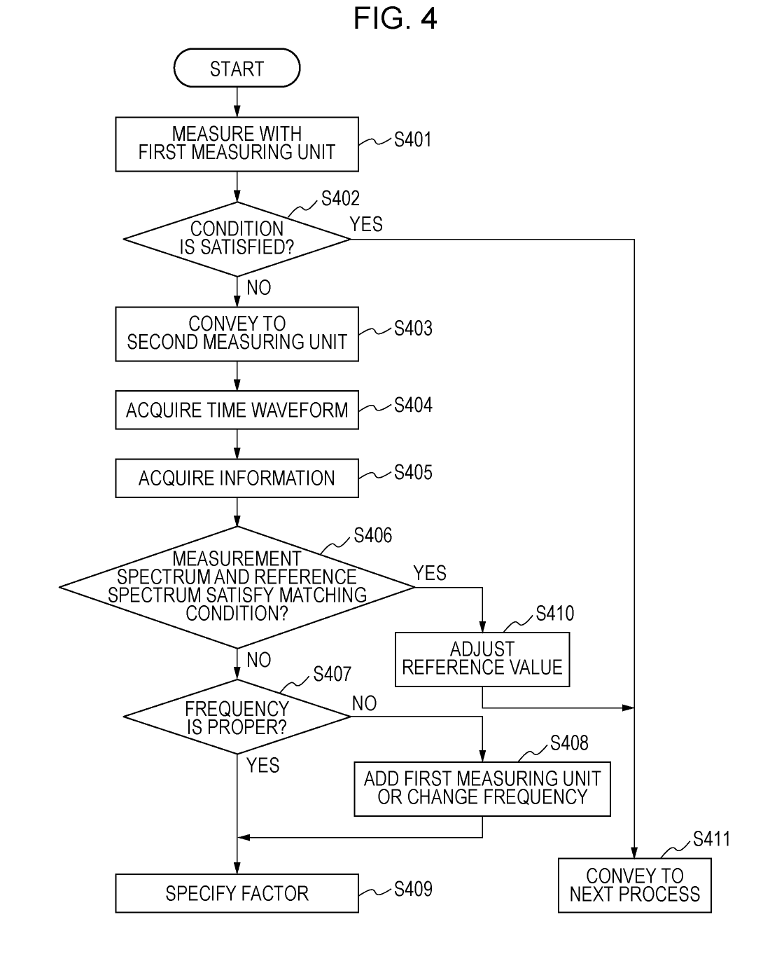

Referring to FIG. 4, an inspection method of determining whether or not an inspection object 108 has a possibility of being a defective product and acquiring information of the inspection object 108 by using an apparatus 300 is described. FIG. 4 is a flowchart explaining an example of the inspection method by the apparatus 300.

First, a plurality of the generating portions 110 and a plurality of the lenses 113 of the third measuring unit 201 irradiate a particulate material 108 passing through the detection region 140 with terahertz waves with a plurality of different frequencies. The detecting portion 111 detects the terahertz waves transmitted through the inspection object 108 to measure the intensities of the terahertz waves (S401). Accordingly, by using the detection result of the detecting portion 111, the intensity distribution, transmissivity, or reflectivity of the terahertz waves transmitted through the inspection object 108 can be obtained. In this embodiment, by using the measurement result of the intensity measurement, the transmissivity of the inspection object 108 is acquired. The irradiation positions with the terahertz waves with respect to the particulate material 108 at the same time are different depending on the frequency. The determining portion 103 references the conveying speed of the conveying unit 21, and synchronizes the detection results of the detecting portion 111 per the same irradiation position.

Then, the determining portion 103 compares the transmissivity acquired in step S401 with the reference value of the transmissivity referenced from the memory portion 106 per the detecting element 131 (S402). In this case, for all the plurality of frequencies, if it is determined that the transmissivity acquired form the measurement result is within the range of the reference value, it is determined as having no possibility of being a defective product, and the good product is successively conveyed in the conveying direction 12 toward the next process (S411).

With at least one frequency, if it is determined that the transmissivity is outside the range of the reference value, it is determined that there is a possibility of being defective, and the separating unit 104 arranged downstream of the detection region 140 in the conveying direction 10 sends the particulate material 108 with a possibility of being a defective product in the conveying direction 11 (S403). Then, the second measuring unit 102 successively measures the time waveform of the particulate material 108 separated by the separating unit 104 in the conveying direction 11 (S404).

The information acquiring portion 105 acquires information of the particulate material 108, such as the shape and optical-characteristic spectrum, from the obtained time waveform (S405). The information acquiring portion 105 compares the spectrum of the optical characteristics (measurement spectrum) included in the acquired information of the particulate material 108 and being the same as the optical characteristics of the reference spectrum stored in the memory portion 106 with the reference spectrum (S406). As the result of comparison, if the measurement spectrum satisfies the matching condition with the reference spectrum, the determining portion 103 adjusts the reference value that is used for determining the presence of a possibility of being a defective product (S410). To be specific, the width of the reference value of the transmissivity or reflectivity with the frequency determined as having a possibility of being a defective product is expanded or other measure is taken. Also, the process goes to step S411, and the inspected particulate material 108 is conveyed as a good product to the next process.

If the measurement spectrum and the reference spectrum do not satisfy the matching condition, the reference spectrum is compared with the measurement spectrum, and it is checked whether or not the frequency used in the inspection for the particulate material 108 in the third measuring unit 201 is the frequency suitable for the comparison of spectra (S407). To be specific, it is checked whether or not the frequency is a frequency that causes the largest difference to be generated between the spectra. If the frequency is not the frequency that causes the largest difference, the information acquiring portion 105 gives the third measuring unit 201 a command of adding a new first measuring unit 101 or gives any of the plurality of first measuring units 101 a command of changing the frequency to be used for measurement (S408). Next, matching between the spectrum of a defective product and the measurement spectrum is executed with reference to the database of a defective product stored in the memory portion 106, and the factor of generation of a defective product is specified (S409). The order of steps S407 and S409 may be switched or steps S407 and S409 may be executed simultaneously.

With this embodiment, it is determined whether or not an inspection object satisfies a predetermined condition in line, and information of the inspection object that does not satisfy the predetermined condition can be obtained. For example, the presence of a possibility of being a defective product is determined for an inspection object, and information of the inspection object determined as having a possibility of being a defective product can be obtained. Also, since it can be rechecked whether the predetermined condition is satisfied or not by using the information of the inspection object acquired by the information acquiring portion, the accuracy of the inspection can be increased. Also, the processing for specifying the factor of abnormality can be executed by using the information of the inspection object acquired by the information acquiring portion. Further, if a new factor not included in the database stored in the memory portion 106 is present, the spectrum of a defective product generated by the new factor is added to the database, and hence the accuracy of the inspection can be increased.

Since each of the plurality of first measuring units 101 changes the frequency of the terahertz wave used for the measurement based on the inspection result, the accuracy of determination for defectiveness by the determining portion 103 is increased and various types of defectiveness can be handled. Further, for example, if the factor of abnormality acquired from the information of the inspection object is fed back to the manufacturing process and the condition in the manufacturing process is changed, this may contribute to restriction of generation of a defective product.

### Third Embodiment

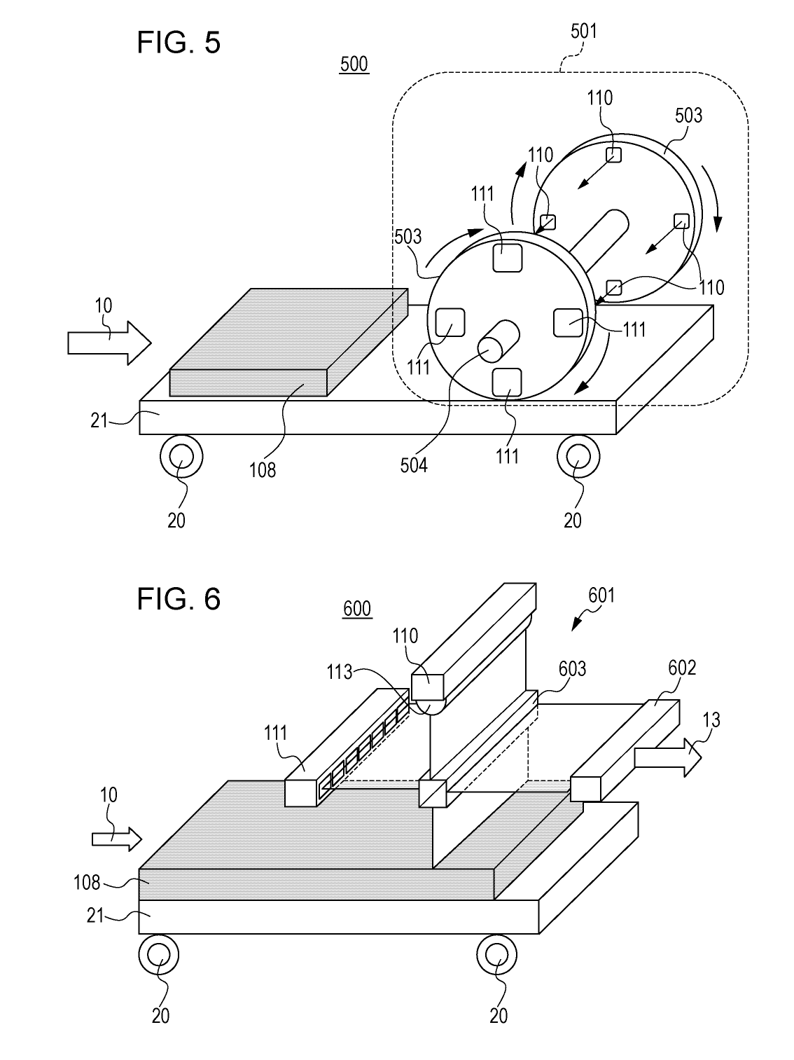

An inspection apparatus 500 (hereinafter, referred to as “apparatus 500”) according to a third embodiment is described with reference to FIG. 5. FIG. 5 is a schematic illustration explaining an example of a configuration of a first measuring unit 501 that executes intensity measurement. The configuration other than the first measuring unit 501 and the inspection method are similar to those of any of the above-described embodiments, and hence the description is omitted.

The apparatus 500 differs from the first embodiment in that the apparatus 500 executes intensity measurement on a particulate material 108 arranged on the conveying unit 21 from side surfaces of the conveying unit 21. This is effective, for example, for a case in which a terahertz wave transmitted through the conveying unit 21 is detected or a case in which the material of the conveying unit 21 is a material that absorbs a terahertz wave. Also, it is effective for a case in which a terahertz wave emitted on an inspection object from the generating portion 110 through the lens 113 is scattered by depressed and projected portions of the surface of the conveying unit 21 and the terahertz wave cannot be detected by the detecting portion 111.

The first measuring unit 501 in the apparatus 500 includes two wheels 503, a shaft 504, a plurality of generating portions 110, and a plurality of detecting portions 111. The plurality of generating portions 110 are arranged at one of the two wheels 503. The plurality of detecting portions 111 are arranged at the other. At this time, the plurality of generating portions 110 and the plurality of detecting portions 111 are arranged to respectively face each other. With this configuration, the presence of defectiveness of the particulate material 108 can be inspected while the influences by the material if the conveying unit 21 and the depressed and projected portions of the surface are decreased. Also, by rotating the wheels 503, the respective detecting portions 111 can detect a terahertz wave transmitted through the particulate material 108 and a terahertz wave transmitted through a portion where the particulate material 108 is not present. Hence, the reference can be updated whenever necessary and the measurement accuracy of the transmissivity is increased.

Also, by providing a frame (not shown) or the like at the conveying unit 21 and adjusting the thickness of the particulate material 108 in the propagating direction of the terahertz wave generated by the generating portion 110, the measurement accuracy can be further increased. For example, in a case of a particulate material containing a high water content, the terahertz wave may be absorbed to the water and is hardly transmitted through the particulate material. Owing to this, if the thickness of the particulate material 108 in the propagating direction of the terahertz wave is decreased to allow the terahertz wave to be easily transmitted through the particulate material 108, the detecting portion 111 can execute detection.

In the case of this embodiment, since the first measuring unit 501 rotates around the shaft 504, power supply to the generating portions 110 and the detecting portions 111 and transmission of the detection results of the detecting portions 111 may occasionally have difficulty. In this case, as the method of supplying power to the generating portions 110 and the detecting portions 111, a non-contact electric power transmission method using, for example, an electromagnetic induction system or an electrical wave system may be used, or a battery may be arranged in the shaft 504 or the wheels 503. Also, the transmission of the detection results of the detecting portions 111 to the determining portion 103 may use wireless communication.

Now, the number of revolutions of the wheels 503 is considered. It is assumed that the conveying unit 21 conveys the particulate material 108 at a speed of 10 m per minute. In this case, the number of revolutions required for determination by the first measuring unit 501 every 1 mm is at least 167 Hz. If the speed at which the conveying unit 21 conveys the particulate material 108 is sufficiently higher than the assumed conveying speed and the number of revolutions is insufficient, the plurality of generating portions 110 and the plurality of detecting portions 111 that execute measurement by using terahertz waves with the same frequency may be arranged in the first measuring unit 501. Also, a plurality of the first measuring units 501 may be arranged along the conveying direction 10. In this case, each of the first measuring units 501 may include the plurality of generating portions 110 and the plurality of detecting portions 111 that generate and detect terahertz waves with the same frequency, and hence each of the first measuring units 501 may execute measurement. Alternatively, the plurality of generating portions 110 and the plurality of detecting portions 111 that generate and detect terahertz waves with different frequencies may be arranged and may execute measurement. If the plurality of measuring units 501 that execute measurement by using terahertz waves with the same frequency are provided, the frequency may be changed every first measuring unit 501. As described above, by considering the arrangement, the inspection speed can be flexibly changed in accordance with the conveying speed of the conveying unit 21.

With this embodiment, it is determined whether or not an inspection object satisfies a predetermined condition in line, and information of the inspection object that does not satisfy the predetermined condition can be acquired. For example, the presence of a possibility of being a defective product is determined for an inspection object, and information of the inspection object determined as having a possibility of being a defective product can be obtained. Also, since it can be rechecked whether the predetermined condition is satisfied or not by using the information of the inspection object acquired by the information acquiring portion, the accuracy of the inspection can be increased. Also, the processing for specifying the factor of abnormality can be executed by using the information of the inspection object acquired by the information acquiring portion. Further, if a new factor not included in the database stored in the memory portion 106 is present, the spectrum of a defective product generated by the new factor is added to the database, and hence the accuracy of the inspection can be increased.

Since each of the plurality of first measuring units 501 changes the frequency of the terahertz wave used for the measurement based on the inspection result, the accuracy of determination for defectiveness by the determining portion 103 is increased and various types of defectiveness can be handled. Further, for example, if the factor of abnormality acquired from the information of the inspection object is fed back to the manufacturing process and the condition in the manufacturing process is changed, this may contribute to restriction of generation of a defective product.

### Fourth Embodiment

An inspection apparatus 600 (hereinafter, referred to as “apparatus 600”) according to a fourth embodiment is described with reference to FIG. 6. FIG. 6 is a schematic illustration explaining an example of a configuration of a first measuring unit 601 that executes intensity measurement. The configuration other than the first measuring unit 601 and the inspection method of the apparatus 600 are similar to those of any of the above-described embodiments, and hence the description is omitted.

The apparatus 600 includes the generating portion 110, the detecting portion 111, a branching portion 603, and an optical-path-length changing portion 602. The branching portion 603 branches a reflected wave into two, the reflected wave being generated such that the terahertz wave generated by the generating unit 110 is reflected by the particulate material 108. One of terahertz waves branched by the branching portion 603 is reflected by the optical-path-length changing portion 602 and goes toward the detecting portion 111. The other of the terahertz waves directly goes toward the detecting portion 111. The detecting portion 111 detects an interference wave of the aforementioned two terahertz waves.

The optical-path-length changing portion 602 is a portion that changes an optical-path-length difference between the optical path lengths of the two terahertz waves branched at the branching portion 603 to positions at which the respective terahertz waves are incident on the terahertz-wave detecting portion 111. In this embodiment, a mirror that moves at high speed in a movable direction 13 and a direction opposite to the movable direction 13 is used. At this time, the mirror serving as the optical-path-length changing portion 602 is required to move in the movable direction 13 and the opposite direction at high speed for executing 100-percent inspection in line although the moving speed depends on the conveying speed of the conveying unit 21 for conveying the particulate material 108. If the optical-path-length changing portion 602 is moved, the optical path length of the terahertz wave that is incident on the detecting portion 111 after the terahertz wave is reflected by the optical-path-length changing portion 602 is changed. By detecting the interference wave that changes in accordance with the change in optical path length, the apparatus 600 can acquire information of the structure of the particulate material 108 in the propagating direction of the terahertz wave in the particulate material 108, in addition to the average transmissivity or average reflectivity of the terahertz wave propagating through the particulate material 108.

With this embodiment, it is determined whether or not an inspection object satisfies a predetermined condition in line, and information of the inspection object that does not satisfy the predetermined condition can be obtained. For example, the presence of a possibility of being a defective product is determined for an inspection object, and information of the inspection object determined as having a possibility of being a defective product can be obtained. Also, since it can be rechecked whether the predetermined condition is satisfied or not by using the information of the inspection object acquired by the information acquiring portion, the accuracy of the inspection can be increased. Also, the processing for specifying the factor of abnormality can be executed by using the information of the inspection object acquired by the information acquiring portion. Further, if a new factor not included in the database stored in the memory portion 106 is present, the spectrum of a defective product generated by the new factor is added to the database, and hence the accuracy of the inspection can be increased.

Since the first measuring unit 601 changes the frequency of the terahertz wave used for the measurement based on the inspection result, the accuracy of determination for defectiveness by the determining portion 103 is increased and various types of defectiveness can be handled. Further, for example, if the factor of abnormality acquired from the information of the inspection object is fed back to the manufacturing process and the condition in the manufacturing process is changed, this may contribute to restriction of generation of a defective product.

### Fifth Embodiment

An inspection apparatus in this embodiment is configured such that, in the apparatus 100 of the first embodiment, the measurement result of the first measuring unit 101 is referenced when the information acquiring portion 105 specifies the factor of not satisfying the predetermined condition. To be specific, by referencing the measurement result of the first measuring unit 101, a single spectrum or a plurality of spectra having a possibility of matching with the measurement spectrum of the inspection object 108 is extracted from the plurality of spectra included in the database.

That is, in step S207, the measurement spectrum of the inspection object 108 is compared with the database stored in the memory portion 106, and a spectrum to be compared with the measurement spectrum is extracted when the factor of that the inspection object 108 does not satisfy the predetermined condition is specified. Accordingly, the measurement spectrum is no longer required to be compared with all spectra included in the database, and processing of specifying the factor of defectiveness by the information acquiring portion 105 can be further quickly executed.

As another embodiment, the inspection apparatus may have a configuration that executes measurement in the second measuring unit 102 based on the measurement result of the first measuring unit 101. To be specific, a region (measurement region) where the second measuring unit 102 executes measurement is determined from a region where an inspection object 108 is arranged, with reference to the measurement result of the first measuring unit 101.

Since the first measuring unit 101 has the plurality of detecting elements 131, the position at which the factor of defectiveness is present (for example, the position at which a foreign substance 107 is mixed) can be predicted from the detection results of the respective detecting elements 131. Hence, the position where the factor of defectiveness is present is predicted from the measurement result of the first measuring unit 101, only the region including the position is determined as the measurement region, and the measurement region is measured by the second measuring unit 102.

In this case, it is desirable that the arrangement state of the inspection object 108 when measured by the first measuring unit 101 and the arrangement state of the inspection object 108 when expected by the second measuring unit 102 are not changed. If the arrangement states are different, it may be difficult to predict the position at which the factor of defectiveness from the measurement result of the first measuring unit 101. Owing to this, it is desirable to execute measurement without using the checker 127.

With this configuration, as compared with the case in which the entire region where the inspection object 108 is arranged is measured, the measurement time of the second measuring unit 102 can be decreased.

As described above, with the measurement apparatus of this embodiment, or with the inspection apparatus as an aspect of the present invention, it is determined whether or not an inspection object satisfies a predetermined condition in line, and information of the inspection object that does not satisfy the predetermined condition can be obtained. Also, since the measurement result of the first measuring unit 101 is used for the measurement of the second measuring unit 102 or the processing of the information acquiring portion 105, the measurement can be further efficiently executed.

The desirable embodiments of the present invention have been described above; however, the present invention is not limited to the embodiments and may be modified or changed in various ways within the scope of the invention.

For example, in any of the above-described embodiments, the determining portion 103 references the numerical value acquired from the average of the measurement results of good products as the reference value to be referenced by the memory portion 106; however, it is not limited thereto. The reference value may be set on the basis of the measurement results of defective products. In this case, a frequency with which the intensity of the terahertz transmitted through the good product does not overlap the reference value acquired on the basis of the measurement result of the defective product is selected, and the reference value and the measurement result are compared with each other with the frequency. Only if the measurement result of the intensity measurement is within the reference values, it is determined that there is a possibility of being a defective product. If the measurement result is outside the range of the reference value, it is determined that the particulate material 108 has no possibility of being a defective product. With this technique, a defective product that is generated due to specific abnormality can be easily found.

Also, when it is determined whether the predetermined condition is satisfied or not by using the measurement result of the intensity measurement and the reference value, the intensity being the measurement result of the intensity measurement may be directly used, or the transmissivity or reflectivity of the particulate material 108 acquired from the measurement result may be used. The determination may be made on the basis of the type of reference value stored in the memory portion 106, or may be properly made by a user.

The measuring unit 102 according to any of the above-described embodiments uses the retardation stage serving as the adjusting portion 122 that adjusts the time point at which the detecting portion 125 detects the pulse wave, and also uses the third controller 123; however, the configuration is not limited thereto. The measuring unit 102 may be only required to adjust the time point of detecting the pulse wave. For example, a light source that outputs a femto-second laser light to be incident on the generating portion 124 and a light source that outputs a femto-second laser light to be incident on the detecting portion 125 are provided, and the respective light sources may change the time points of outputting the femto-second laser light.

The inspection apparatus and the inspection method described in any of the respective embodiments may be applied to PAT (Process analytical technology) in manufacturing of medicines. PAT is technology and system that executes analysis, management, design, etc., of each manufacturing process, and finally guarantees the quality of product by monitoring the manufacturing process of medicines in real time. Also, the medicines as the products manufactured thereby are included in the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-211198 filed Oct. 15, 2014 and No. 2015-169238 filed Aug. 28, 2015, which are hereby incorporated by reference herein in their entirety.

What is claimed is:

1. An inspection apparatus configured to inspect a plurality of inspection objects, the inspection apparatus comprising:
a first measuring unit configured to measure terahertz waves transmitted through the plurality of respective inspection objects or reflected by the plurality of respective inspection objects;
a determining portion configured to determine whether a predetermined condition is satisfied by using a measurement result of the first measuring unit;
a separating unit configured to separate the plurality of inspection objects into an inspection object that satisfies the predetermined condition and an inspection object that does not satisfy the predetermined condition based on a determination result of the determining portion; and
a second measuring unit configured to measure a time waveform of a terahertz-wave pulse transmitted through an inspection object that does not satisfy the predetermined condition separated by the separating unit or a terahertz-wave pulse reflected by the inspection object that does not satisfy the predetermined condition separated by the separating unit.

2. The inspection apparatus according to claim 1, wherein a measurement time of the first measuring unit is shorter than a measurement time of the second measuring unit.

3. The inspection apparatus according to claim 1, wherein a frequency range of the terahertz waves used by the first measuring unit is narrower than a frequency range of the terahertz-wave pulses used by the second measuring unit.

4. The inspection apparatus according to claim 1,
wherein the first measuring unit includes
a terahertz-wave generating portion configured to generate a terahertz wave, and
a terahertz-wave detecting portion configured to detect terahertz waves transmitted through the plurality of respective inspection objects or terahertz waves reflected by the plurality of respective inspection objects by using a plurality of detecting elements, and
wherein the second measuring unit includes
a pulse-wave irradiating portion configured to irradiate the inspection object that does not satisfy the predetermined condition with a terahertz-wave pulse,
a pulse-wave detecting portion configured to detect a terahertz-wave pulse transmitted through the inspection object that does not satisfy the predetermined condition or a terahertz-wave pulse reflected by the inspection object that does not satisfy the predetermined condition, and
a waveform acquiring portion configured to acquire a time waveform of the terahertz-wave pulses by using a detection result of the pulse-wave detecting portion.

5. The inspection apparatus according to claim 1, wherein the second measuring unit acquires a time waveform of a terahertz-wave pulse transmitted through a region including a position of the inspection object at which the predetermined condition is not satisfied or a terahertz-wave pulse reflected in the region, by using the measurement result of the first measuring unit.

6. The inspection apparatus according to claim 1, further comprising an information acquiring portion configured to acquire information of the inspection object that does not satisfy the predetermined condition by using a measurement result of the second measuring unit.

7. The inspection apparatus according to claim 6, further comprising a frequency controller configured to change a frequency of the terahertz waves used for the measurement by the first measuring unit based on the information of the inspection object that does not satisfy the predetermined condition acquired by the information acquiring portion.

8. The inspection apparatus according to claim 7,
wherein the frequency controller includes a third measuring unit configured to measure terahertz waves transmitted through the plurality of respective inspection objects or terahertz waves reflected by the plurality of respective inspection objects based on the information of the inspection object that does not satisfy the predetermined condition acquired by the information acquiring portion, and
wherein the frequency of the terahertz waves used for the measurement by the first measuring unit differs from a frequency of the terahertz waves used for the measurement by the third measuring unit.

9. The inspection apparatus according to claim 6, further comprising:
a plurality of the first measuring units; and
a frequency controller configured to change a frequency of terahertz waves used for measurement by each of the plurality of first measuring units based on the information of the inspection object that does not satisfy the predetermined condition acquired by the information acquiring portion.

10. The inspection apparatus according to claim 6, wherein the information acquiring portion compares a measurement spectrum of optical characteristics of the inspection object that does not satisfy the predetermined condition acquired by the information acquiring portion with a reference spectrum of the inspection object that satisfies the predetermined condition.

11. The inspection apparatus according to claim 10, wherein, in a case where the measurement spectrum and the reference spectrum do not satisfy a matching condition, the information acquiring portion compares a plurality of spectra stored in a database with the measurement spectrum.

12. The inspection apparatus according to claim 11, wherein the information acquiring portion extracts a single spectrum or a plurality of spectra that are compared with the measurement spectrum from the plurality of spectra based on the measurement result of the first measuring unit.

13. The inspection apparatus according to claim 1, wherein the first measuring unit irradiates each of the plurality of inspection objects with a linear terahertz wave.

14. The inspection apparatus according to claim 1,
wherein the first measuring unit includes
a terahertz-wave generating portion configured to generate a terahertz wave,
a branching portion configured to branch terahertz waves from the plurality of respective inspection objects into two,
a terahertz-wave detecting portion configured to detect an interference wave of the two terahertz waves branched at the branching portion, and
an optical-path-length changing portion configured to change an optical-path-length difference between an optical path length to a position at which one of the terahertz waves branched at the branching portion is incident on the terahertz-wave detecting portion and an optical path length to a position at which the other of the terahertz waves is incident on the terahertz-wave detecting portion.

15. The inspection apparatus according to claim 1,
wherein the first measuring unit includes a terahertz-wave generating portion configured to generate a terahertz wave, and
wherein the terahertz-wave generating portion includes a resonant tunneling diode.

16. The inspection apparatus according to claim 1,
wherein the first measuring unit includes a terahertz-wave generating portion configured to generate a terahertz wave, and
wherein the terahertz-wave generating portion includes a Schottky barrier diode.

17. The inspection apparatus according to claim 1, wherein the plurality of inspection objects includes a tablet, a plastic member, a toner, or a nanocomposite material.

18. An inspection method for an inspection apparatus configured to inspect a plurality of inspection objects, the inspection method comprising:
measuring, as a first measuring, terahertz waves transmitted through the plurality of respective inspection objects or reflected by the plurality of respective inspection objects;
determining whether a predetermined condition is satisfied by using a measurement result of the first measuring;
separating the plurality of inspection objects into an inspection object that satisfies the predetermined condition and an inspection object that does not satisfy the predetermined condition based on a determination result of the determining portion; and
measuring, as a second measuring, a time waveform of a terahertz-wave pulse transmitted through a separated inspection object that does not satisfy the predetermined condition or a terahertz-wave pulse reflected by the separated inspection object that does not satisfy the predetermined condition.

19. A computer-readable storage medium storing a program to cause a computer to perform an inspection method for an inspection apparatus configured to inspect a plurality of inspection objects, the inspection method comprising:
measuring, as a first measuring, terahertz waves transmitted through the plurality of respective inspection objects or reflected by the plurality of respective inspection objects;
determining whether a predetermined condition is satisfied by using a measurement result of the first measuring;
separating the plurality of inspection objects into an inspection object that satisfies the predetermined condition and an inspection object that does not satisfy the predetermined condition based on a determination result of the determining portion; and
measuring, as a second measuring, a time waveform of a terahertz-wave pulse transmitted through a separated inspection object that does not satisfy the predetermined condition or a terahertz-wave pulse reflected by the separated inspection object that does not satisfy the predetermined condition.
